(19) United States
(12) Patent Application Publication
(10) Pub. No.: US 2008/0092395 A1
(43) Pub. Date: Apr. 24, 2008

(54) METHOD FOR WRAPPING AND PROTECTING EATING UTENSILS

(75) Inventors: Donald R. Belanger, Merrimack, NH (US); Ronald L. Downing, Merrimack, NH (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: George Gordon Associates, Inc., Merrimack, NH (US)

(21) Appl. No.: 11/870,652

(22) Filed: Oct. 11, 2007

Related U.S. Application Data
(60) Provisional application No. 60/862,476, filed on Oct. 23, 2006.

(51) Int. Cl. B26B 3/00; A47J 43/28; B65B 51/10; B65D 85/00

(52) U.S. Cl. 30/165; 206/373; 30/322; 30/324; 53/463

(57) ABSTRACT

A method of wrapping and protecting utensils from being contaminated by dirt and bacteria includes wrapping only that portion of the utensil that is to come in contact with a users mouth. The wrap may include plastic film, foil or paper. By wrapping only that portion of the utensil the comes in contact with the users mouth, the utensils can be held in the unwrapped portion of the utensil that does not come in contact with a user's mouth by automated manufacturing equipment to move, wrap and pack utensils without the need for human handling. The use of significantly less wrapping material greatly reduces the cost of the wrapping while allowing machines to handle the utensils thereby eliminating the possibility of contamination to the utensils caused by human handling. A two-part container is also provided. A bottom portion of the container contains the unwrapped portion of the utensil while the top portion is removable to expose, to be grasped by a user, the wrapped portion of the utensil that is intended to come into contact with a human's mouth.

### CROSS-REFERENCE TO RELATED APPLICATIONS

This application claims the benefit of U.S. Provisional Application No. 60/862,476 filed Oct. 23, 2006 and which is fully incorporated herein by reference.

### TECHNICAL FIELD

The present invention relates to packaging industry and more particularly, relates to the packaging of eating utensils such as used in the fast food or travel industry.

### BACKGROUND INFORMATION

Fast food restaurants and other eating establishments as well as the travel industry including airlines, boats, trains and the like rely heavily on prepackaged, disposable eating utensils to serve their customers. After purchasing their food, customers can either eat this food at the establishment using the prepackaged utensils or alternatively can take their food and the prepackaged eating utensils to go for consumption off premises.

Typically the eating utensils provided by these institutions are plastic utensils which are prepackaged either alone, or in combination with or without other products such as condiments (salt and paper for example), napkins and the like. To date, the industry has completely packaged these utensils by providing them in a little plastic “pouch”. In order to package these utensils, someone must physically take the utensils (and other items) to be packaged, and insert them into a small plastic pouch, which is then sealed and is ready for use. This prior art method is labor intensive and requires that human hands touch nearly each and every utensil or other item. This is very labor intensive and also unsanitary.

In addition, one of the most significant costs in prepackaged eating utensils is the cost of the packaging material itself. Although the average consumer would not expect such costs for the thin plastic film that is commonly utilized, to enclose eating utensils is quite expensive and requires quite a bit of energy to manufacture the film.

Accordingly, what is needed system and method for packaging eating utensils, which does not require human intervention and which significantly reduces the amount of packaging material required and thereby reduces the costs.

### SUMMARY

The present invention therefore features a method for packaging eating utensils, which significantly reduces the amount of packaging film or other material required while keeping the utensils sanitary during shipping and display and allowing for near complete automation of the packaging process.

Accordingly, the present invention discloses the concept of wrapping only a portion of the eating utensil in packaging material. The portion to be wrapped includes only the portion that is generally in contact with food or with the user's mouth. Accordingly, in the case of a fork or spoon, only the end of those utensils would be packaged. This represents a savings of approximately ⅔ or more of the wrapping material. In the case of a knife, only the blade of the knife would be wrapped, representing a savings of approximately 50% of the packaging material. The packaging material can include a thin plastic film, which can be heat-sealed or alternatively, a heat shrinking material that is heat shrunk around end of the utensil. Any eating utensil is contemplated by the present invention in addition to the more traditional forks, knives, and spoons. In addition, packaging films can include not only plastics and vinyl but also paper.

Because the utensils can be handled automatically by machine, the utensils maybe boxed in a two-piece storage box, which separates along the length of the utensil. This provides not only a convenient shipping mechanism for the utensils but also, once on site, the “top” of the box can be removed leaving the utensils standing in the bottom portion of the box for display and ease of remove for usage.

It is important to note that the present invention is not intended to be limited to a system or method which must satisfy one or more of any stated objects or features of the invention. It is also important to note that the present invention is not limited to the preferred, exemplary, or primary embodiment(s) described herein.

### BRIEF DESCRIPTION OF THE DRAWINGS

These and other features and advantages of the present invention will be better understood by reading the following detailed description, taken together with the drawings wherein:

FIG. 1 is a front schematic representation of various utensils wrapped in accordance with the method of the present invention; and

FIG. 2 is a schematic representation of a shipping, storage and display container for housing the utensils wrapped in accordance with the method of the present invention.

### DETAILED DESCRIPTION OF THE PREFERRED EMBODIMENTS

The present invention features a method for wrapping utensils such as knives, forks, spoons, chopsticks and the like which utilizes significantly less packaging material and which allows the utensils to be handled mechanically by machine, thereby automating the wrapping, boxing and shipping process.

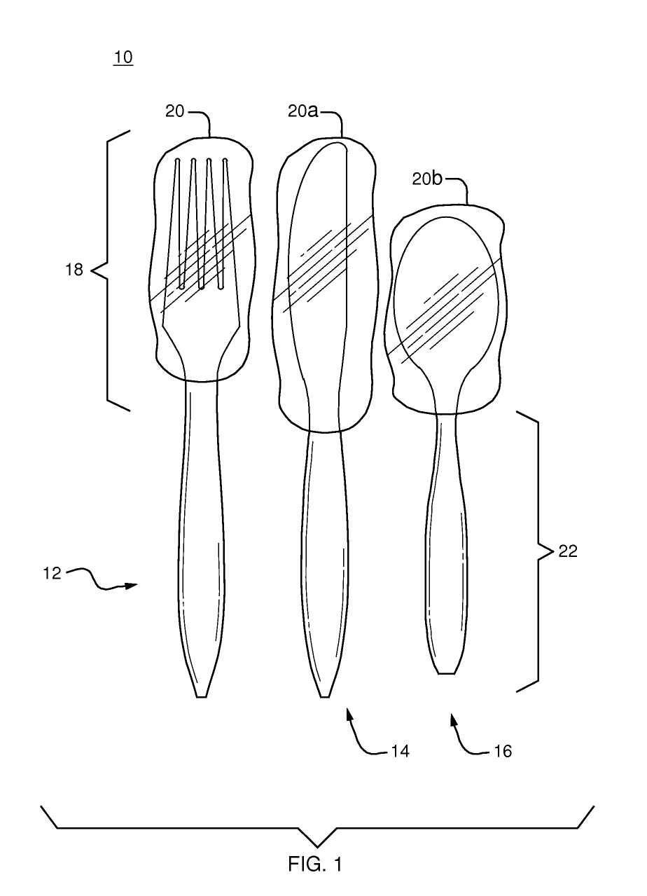

In accordance with the teachings of the present invention, various utensils 10, FIG. 1, such as fork 12, knife 14 and spoon 16 can be partially wrapped protecting that portion of the utensil which will come into contact with the users mouth. As shown in connection with fork 12, the upper portion 18 of the fork 12 is a wrapped with a material 20 such as a thin plastic film, paper, foil or the like. The material 20 may include a plastic film which is wrapped around the utensil or alternatively, which is heat shrunk directly to the utensil. In a similar manner, knife 20 also includes a region 18 covered by material 20a while spoon 16 is covered by material 20b.

The remainder of the utensils indicated generally by region 22 is not covered in any sort of protective member and thus, the utensils can be handled in this region using automated machinery as is presently used to handle on covered or unprotected utensils and as is well known in the art. Thus, the present invention allows for higher packaging speeds, uses less than one third or so of the packaging material and addresses the sanitation issue involved in packaging since there is no hand packing required. The ability to use automated equipment facilitates less handling of the utensils by human hands.

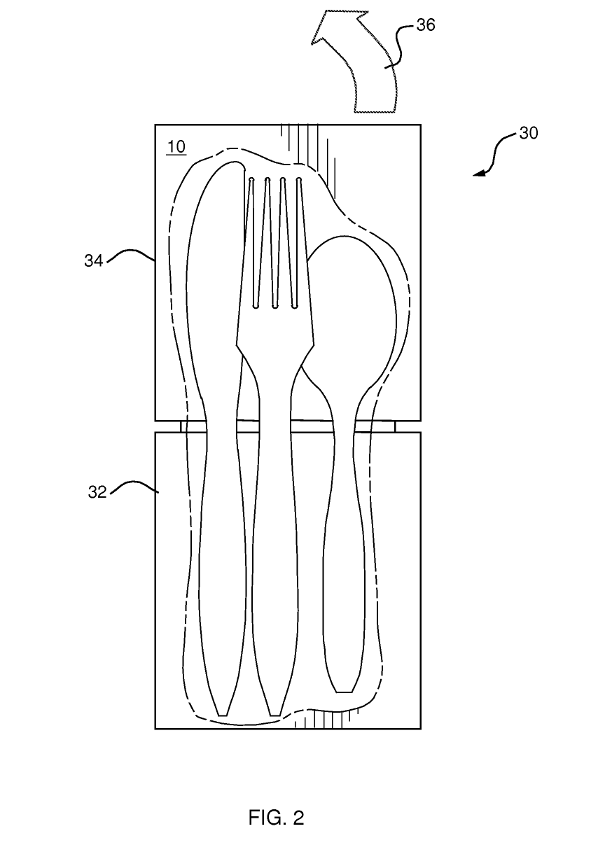

Utensils wrapped in accordance with the teachings of the present invention as well as utensils wrapped in accordance with any prior teachings can be packaged, storage, shipped and display the in packaging box 30, FIG. 2, in accordance with the teachings of another aspect of the present invention. Box 30 is a two piece box consisting of bottom half 32 and top half 34. The utensils 10 are loaded in the box with that portion of the utensil which allows it to be identified and grabbed in an upwardly direction. During shipping and storage, the utensils 10 are covered by the top half 34 of box 30. To display the utensils and allow them to be utilized, top half 34 is removed in the direction indicated generally by arrow 36 leaving the bottom half 32 of the box to hold and display the utensils 10.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the allowed claims and legal equivalents thereto.

What is claimed is:

1. A utensil including a portion that comes in contact with a human's mouth and a portion that does not generally come in contact with said human's mouth, said utensil partially wrapped and protected with wrapping only about said portion of the utensil which comes in contact with said human's mouth.

2. The utensil of claim 1 wherein the utensil is selected from the group consisting of a knife, a fork and a spoon.

3. The utensil of claim 1 wherein the wrapping is selected from the group consisting of a thin plastic film, a foil and paper.

4. The utensil of claim 1 wherein the wrapping is a thin plastic film heat shrunk around that portion of the utensil that comes in contact with the human's mouth.

5. A method of wrapping and protecting a utensil, said utensil including a portion that comes into contact with a human's mouth and a portion that does not generally come into contact with a human's mouth, said method comprising the act of wrapping only said portion of the utensil which comes in contact with a human mouth.

6. A storage and display container for a utensil, said utensil including a portion that comes in contact with a human's mouth and a portion that does not generally come in contact with said human's mouth, said utensil partially wrapped and protected only about said portion of the utensil which comes in contact with said human's mouth, said container comprising:
a top portion and a bottom portion, said top and bottom portions configured, in a first mode, for generally completely containing a plurality of said utensils, said portion of each said plurality of utensils that does not generally come in contact with said human's mouth generally contained in said bottom portion of said container and said partially wrapped and protected portion that comes in contact with a human's mouth generally contained in said top portion of said container, said container configured in a second mode for displaying said plurality of contained utensils by removal of said top portion of said container, allowing a user to select one or more utensils from among said plurality of utensils in said container by grasping a selected utensil by said wrapped and protected portion.

7. The utensil of claim 6 wherein the utensil is selected from the group consisting of a knife, a fork and a spoon.

8. The utensil of claim 6 wherein the wrapping is selected from the group consisting of a thin plastic film, a foil and paper.

9. The utensil of claim 8 wherein the wrapping is a thin plastic film heat shrunk around that portion of the utensil that comes in contact with the human's mouth.
